(19) United States
(12) Patent Application Publication
(10) Pub. No.: US 2022/0114628 A1
(43) Pub. Date: Apr. 14, 2022

(54) VEHICLE FUEL EFFICIENCY SYSTEM

(71) Applicant: Toyota Motor Engineering & Manufacturing North America, Inc., Plano, TX (US)

(72) Inventors: Ryan M. Wiesenberg, Ann Arbor, MI (US); Noah Mitchell Einstein, Ann Arbor, MI (US)

(21) Appl. No.: 17/068,479

(22) Filed: Oct. 12, 2020

(51) Int. Cl. G06Q 30/02; G06Q 30/00; G06Q 50/30; G06Q 10/06; G06Q 50/06; G07C 5/08; G01C 21/34; B60K 35/00

(52) U.S. Cl. CPC G06Q 30/0284; G06Q 30/018; G06Q 50/30; G06Q 10/06315; B60K 2370/166; G07C 5/0816; G01C 21/3469; B60K 35/00; G06Q 50/06

(57) ABSTRACT

Methods, systems, and apparatus for improving accuracy of mobility technology. The system includes a vehicle having a fuel sensor configured to detect fuel data indicating vehicle fuel efficiency, and an electronic control unit (ECU) configured to communicate the fuel data via a transceiver. The system also includes a remote data server configured to receive the fuel data from the vehicle, determine a baseline cost associated with a transportation request, and increase or decrease the baseline cost based on the fuel data to determine an adjusted cost. The system also includes a mobile device configured to receive the adjusted cost and render a user interface including the adjusted cost.

### BACKGROUND

### 1. Field

This specification relates to a system and a method for detecting fuel efficiency of a vehicle.

### 2. Description of the Related Art

A vehicle may have an engine or a motor and may be powered by gasoline or electricity. Some vehicles may combust gasoline to power an internal combustion engine to power the vehicle. Some vehicles may have a battery that is charged using electricity, and the battery powers a motor of the vehicle. In yet other vehicles, hydrogen fuel may react with components of a fuel cell to generate electricity to power a motor. Many other vehicles and fuel sources may exist. A fuel efficiency of a vehicle is a rate at which the vehicle consumes fuel (e.g., gasoline, electricity, hydrogen fuel, etc.). Thus, in many contexts, fuel efficiency is expressed in terms of a distance per unit of fuel (e.g., miles per gallon of gasoline (MPG) of miles per gallon gasoline equivalent (MPGe)). Vehicles with better fuel efficiency may be cheaper to operate than vehicles with poorer fuel efficiency.

### SUMMARY

What is described is a system for improving accuracy of mobility technology. The system includes a vehicle having a fuel sensor configured to detect fuel data indicating vehicle fuel efficiency, and an electronic control unit (ECU) configured to communicate the fuel data via a transceiver. The system also includes a remote data server configured to receive the fuel data from the vehicle, determine a baseline cost associated with a transportation request, and increase or decrease the baseline cost based on the fuel data to determine an adjusted cost. The system also includes a mobile device configured to receive the adjusted cost and render a user interface to present the adjusted cost to a user.

Also described is a method for improving accuracy of mobility technology. The method includes detecting, by a fuel sensor of a vehicle, fuel data indicating vehicle fuel efficiency. The method also includes receiving, by a remote data server, the fuel data from the vehicle. The method also includes determining, by the remote data server, a baseline cost associated with a transportation request. The method also includes increasing or decreasing, by the remote data server, the baseline cost based on the fuel data, to determine an adjusted cost. The method also includes receiving, by a mobile device, the adjusted cost. The method also includes rendering, by the mobile device, a user interface to present the adjusted cost to a user.

Also described is a system for improving accuracy of mobility technology. The system includes a plurality of vehicles each having a fuel sensor configured to detect fuel data indicating vehicle fuel efficiency. The system includes a remote data server configured to receive respective fuel data from the plurality of vehicles, determine a baseline cost associated with a transportation request, and increase or decrease the baseline cost based on the respective fuel data to determine an adjusted cost for one or more vehicles of the plurality of vehicles. The system includes a mobile device configured to receive the adjusted cost for the one or more vehicles and render a user interface to present the adjusted costs to a user.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 illustrates a vehicle, according to various embodiments of the invention.

FIG. 2 illustrates multiple vehicles and their fuel efficiency, according to various embodiments of the invention.

FIG. 3 illustrates multiple vehicles and their fuel efficiency, according to various embodiments of the invention.

FIG. 4 illustrates a vehicle and real-time fuel efficiency, according to various embodiments of the invention.

FIG. 5 is a block diagram of the system, according to various embodiments of the invention.

FIG. 6 illustrates a flow diagram of a process performed by the system, according to various embodiments of the invention.

### DETAILED DESCRIPTION

Disclosed herein are systems, vehicles, and methods for improving accuracy of mobility technology. The systems, vehicles, and methods disclosed herein use a number of vehicle sensors to determine fuel efficiency and driver behavior impacting fuel efficiency. The systems and methods described herein are more accurate and responsive than other systems for determining costs of transportation. In addition, the systems and methods described herein may automatically provide real-time adjustments to costs based on driver and vehicle fuel efficiency. Conventionally, when a vehicle provides transportation as a service, the fuel efficiency of the vehicle or the driver are not taken into consideration.

The systems and methods described herein promote the efficient operation of vehicles, thereby improving operations of the vehicles. In addition, the systems and methods described herein provide for improved accuracy of costs associated with transportation technologies.

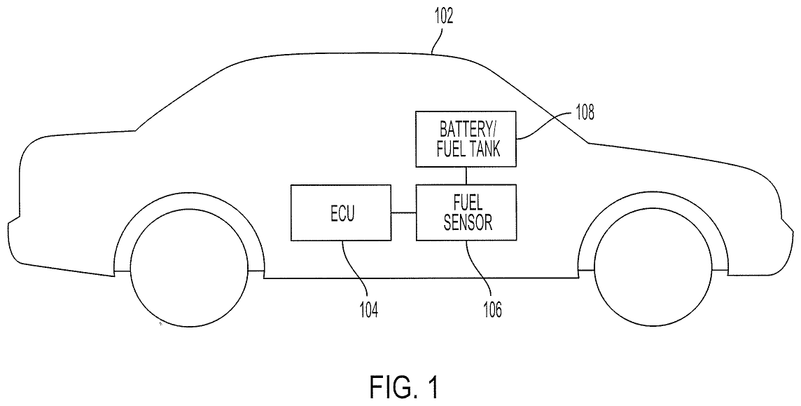

FIG. 1 illustrates a vehicle 102 having an electronic control unit (ECU) 104, a fuel sensor 106, and a fuel tank 108. As used herein, “fuel” may refer to any energy used to power a vehicle, including gasoline, electricity stored in a battery, electricity generated by a fuel cell, hydrogen fuel used by a fuel cell to generate electricity, or natural gas, for example. Accordingly, “fuel tank” may refer to any vessel or device used to store fuel, such as a gasoline tank, a battery, or a hydrogen fuel tank, for example. A “fuel efficiency” of a vehicle refers to a rate at which the vehicle consumes fuel (e.g., gasoline, electricity, hydrogen fuel, etc.) and may be expressed as a ratio of a distance travelled by the vehicle to a unit of fuel.

The fuel sensor 106 is connected to the fuel tank 108. The fuel sensor 106 is configured to detect fuel data associated with the fuel tank 108, such as a fuel level, a fuel consumption rate, or a fuel capacity, for example.

The ECU 104 is communicatively coupled to the fuel sensor 106 and is programmed to control one or more operations of the vehicle 102. The ECU 104 may be one or more computer processors. The ECU 104 may use the fuel data from the fuel sensor 106 to control one or more operations of the vehicle 102. For example, the ECU 104 may control operations of the vehicle 102 based on fuel consumption rate. The ECU 104 may be provided a target fuel consumption rate, and when the vehicle 102 exceeds, or is on pace to exceed, the target fuel consumption rate, the ECU 104 may limit fuel usage by the vehicle 102 to achieve the target fuel consumption rate. The ECU 104 may also communicate the fuel data to one or more computing devices. For example, the ECU 104 may use a vehicle transceiver to communicate the fuel data to a remote data server, which may then communicate the fuel data to mobile devices or other computing devices.

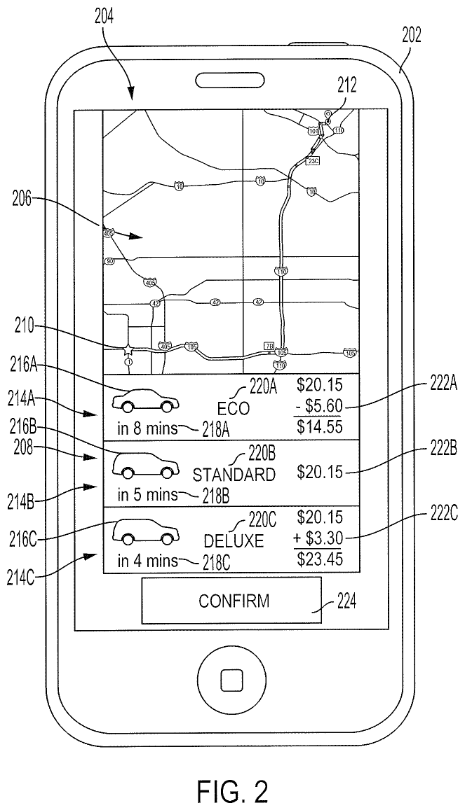

FIG. 2 illustrates a mobile device 202. The mobile device 202 may be any device with a processor, a memory, an input device (e.g., touchscreen, mouse, keyboard, stylus, etc.), an output device (e.g., display screen, touchscreen, etc.), and a transceiver for communicating and receiving data. The mobile device 202 may be used by a user of mobility as a service (MasS). MaaS is a technology that allows users to access transportation without having to be in possession of a vehicle. MaaS technology uses multiple network-connected (e.g., Internet-connected) devices, such as network-connected mobile devices (e.g., mobile device 202) and network-connected vehicles (e.g., vehicle 102). These network-connected devices communicate in real-time to provide users with transportation. For example, a network-connected mobile device may receive a user indication for transportation to a destination location. The network-connected mobile device may communicate a request to a remote data server for vehicles within a threshold vicinity (e.g., by distance or driving time) of the network-connected mobile device. The network-connected mobile device may communicate its location data (detected using a location sensor) to the remote data server in addition to the request for transportation.

The remote data server may communicate a real-time estimate of one or more vehicles in the vicinity of the network-connected mobile device that are available to provide transportation to the user. The real-time estimate may include at least one of a location of the one or more vehicles, an estimated time for the one or more vehicles to arrive to the user's current location, an estimated time to the destination, an estimated cost associated with the transportation, or an estimated route of travel from the current location of the user to the destination location.

The location of the one or more vehicles may be determined by respective location sensors of the one or more vehicles, each configured to detect respective location data, which is communicated to the remote data server. The estimated time for the one or more vehicles to arrive to the user's current location may be determined by the remote data server based on location data from the one or more vehicles and the location data of the network-connected mobile device of the user. In addition, traffic data may be used to determine the estimated time for the one or more vehicles to arrive to the user's current location. The estimated time to the destination location and the estimated route of travel to the destination location may be determined based on traffic data and map data. The estimated cost associated with the transportation may be determined by the remote data server based on at least one of a time of day or day of the week, a fuel efficiency of the vehicle, a demand for transportation services relative to a supply of vehicles, or a size of the vehicle.

The location of the one or more vehicles, the estimated time for the one or more vehicles to arrive to the user's current location, the estimated time to the destination location, the estimated cost associated with the transportation, and the estimated route of travel from the current location of the user to the destination location may all change based on real-time data detected by sensors of the vehicles and real-time traffic data.

The estimated cost may vary from one vehicle to another based on operations of each vehicle. In particular, a fuel efficiency of a particular vehicle may result in a higher or lower cost associated with the transportation of the user to the destination location. The fuel efficiency of a vehicle may be affected by the driver's operation of the vehicle, a fuel efficiency of the propulsion devices (e.g., engine or motor) of the vehicle, a terrain of the route being traversed, and/or traffic conditions of the route being traversed, for example.

The driver's operation of the vehicle may affect a fuel efficiency of a particular vehicle, which may result in a higher or lower cost associated with the transportation of the user to the destination location. For example, a driver may typically drive within 5 miles per hour of the most fuel-efficient speeds on the freeway, or the driver may coast to an intersection, or the driver may draft behind large vehicles (e.g., long-haul trucks, semi-trucks, semi-tractor-trailer truck, etc.) to reduce wind drag. All of these driving behaviors may affect fuel efficiency.

A terrain of the route being traversed may affect fuel efficiency by limiting speeds or decreasing traction. For example, when a vehicle is being driven on a rocky, unpaved road, the maximum speed the vehicle can travel may be much lower than the most fuel-efficient speeds. In another example, when a vehicle is being driven on sandy or muddy roads, the vehicle may have reduced traction, which decreases fuel efficiency. When roads that impact fuel-efficiency are anticipated in the route, an adjustment may be made to the cost of the transportation. In some embodiments, an adjusted fuel efficiency may be determined for these road segments. A cost associated with traversing these road segments may then be determined and combined with a cost associated with traversing the rest of the route, and this cost may be used in determining the total cost for transportation.

Similarly, traffic along the route being traversed may affect fuel efficiency by limiting speeds. For example, when a vehicle is being driven through heavy traffic, the maximum speed the vehicle can travel may be much lower than the most fuel-efficient speeds. When traffic that impacts fuel efficiency is anticipated in the route, an adjustment may be made to the cost of the transportation. In some embodiments, an adjusted fuel efficiency may be determined for these road segments with traffic. A cost associated with traversing these road segments may then be determined and combined with a cost associated with traversing the rest of the route, and this cost may be used in determining the total cost for transportation.

A fuel sensor (e.g., fuel sensor 106) may be used to detect fuel efficiency data associated with the vehicle 102 and/or the driver of the vehicle 102. The fuel efficiency data may be updated in real-time, and may be communicated to the remote data server. The fuel efficiency data may be used to determine an estimated cost associated with a transportation request from the user. This cost may change dynamically based on fluctuations of fuel efficiency of the vehicle and the driver of the vehicle, and the cost to the user may change in real-time accordingly. In many embodiments, the network-connected vehicles and the network-connected mobile devices are in continuous (or periodic) communication with the remote data server, in order to facilitate real-time updating of information of both the vehicle and the mobile device.

In addition to the fuel sensor, other vehicle sensors may be used to detect driver operating data. For example, a brake sensor may detect braking by the driver that increases or decreases fuel efficiency (e.g., frequent abrupt braking may decrease fuel efficiency and braking to coast to a stop may increase fuel efficiency). In another example, an accelerator pedal sensor may detect acceleration by the driver that increases or decreases fuel efficiency (e.g., abrupt acceleration may decrease fuel efficiency and gradual acceleration may increase fuel efficiency). In another example, an engine sensor may detect engine data affecting fuel efficiency, such as use of engine braking. While “engine sensor” is used herein, other propulsion devices and associated sensors may be used, such as a motor sensor or motor/generator sensor being used for a motor or a motor/generator, respectively.

The mobile device 202 is configured to render and display a user interface 204. The processor may render the user interface 204 and the output device may display the user interface 204. The user interface 204 may include a map 206 and a list 208. The map 206 shows the current location 210 of the user as well as the destination 212 of the user. The current location 210 may be automatically detected using a location sensor of the mobile device 202 and the destination location 212 may be received from the user via an input device of the mobile device 202.

The list 208 includes one or more transportation options 214 (e.g., first option 214A, second option 214B, and third option 214C). Each transportation option 214 may include an image of the vehicle, an estimated time of arrival, a class of vehicle, and a cost of the vehicle.

The first option 214A includes an image of the vehicle 216A, a time estimate 218A, a class of vehicle 220A, and a cost 222A associated with the vehicle and the driver. Similarly, the second option 214B includes an image of the vehicle 216B, a time estimate 218B, a class of vehicle 220B, and a cost 222B associated with the vehicle and the driver. Similarly, the third option 214C includes an image of the vehicle 216C, a time estimate 218C, a class of vehicle 220C, and a cost 222C associated with the vehicle and the driver.

For each vehicle, the image of the vehicle 216 may be used to show the user a type of vehicle and/or a make and a model of the vehicle. The time estimate 218 may be determined based on real-time location data of the vehicle (detected by a location sensor of the vehicle) and real-time location data of the mobile device 202 (detected by a location sensor of the mobile device). The class of vehicle 220 may be associated with the type of vehicle. For example, vehicles that meet or exceed a fuel efficiency threshold may be classified as ECO, vehicles that exceed a threshold number of seats or meet a list of amenities may be classified as DELUXE, and all other vehicles may be classified as STANDARD. Any number of criteria may be used to classify vehicles.

The cost associated with the vehicle may be determined based on a fuel efficiency of the vehicle and/or a fuel efficiency of the driver. A baseline cost may be determined and a discount or an additional cost may be applied to the baseline cost. For example, the baseline cost may be $20.15 for the transportation request. This baseline cost may be determined using any number of factors, including a time of day or a day of the week or a demand for transportation services relative to a supply of vehicles.

At least one of the components of the baseline cost may be a cost of operating the vehicle along the requested route. This vehicle operation cost component for the baseline cost may be determined based on fuel costs and fuel efficiency of an average vehicle. The vehicle operation cost may be combined with other costs, such as insurance costs or driver compensation costs, to form the baseline cost.

The baseline cost may be reduced for vehicles with improved fuel efficiency based on fuel data of the vehicle. For example, as shown in FIG. 2, the baseline cost of $20.15 may be reduced by $5.60 for the ECO vehicle. The vehicle may communicate fuel data detected by a fuel sensor of the vehicle to a remote data server, and the remote data server may determine the discount amount based on the fuel data. In some embodiments, the discount is determined by determining a vehicle operation cost for the fuel-efficient vehicle and comparing the vehicle operation cost for the fuel-efficient vehicle with the vehicle operation cost of the baseline cost. In some embodiments, the discount is determined by calculating a discount based on the fuel efficiency of the fuel-efficient vehicle. For example, the fuel efficiency of the vehicle may be 110 miles per gallon gasoline equivalent (MPGe). The fuel efficiency exceeding a threshold value (e.g., 30 miles per gallon, 40 miles per gallon, 50 miles per gallon) may be multiplied by a discount factor (e.g., $0.08, $0.10, $0.12) to determine the discount. Thus, a vehicle with a fuel efficiency of 110 MPGe which exceeds a threshold of 40 MPG by 70 MPG is multiplied by a discount factor of $0.08 to achieve a discount of $5.60. As shown in FIG. 2, the discount, once determined, is shown on the user interface 204.

Conversely, the baseline cost may be increased for vehicles with poorer fuel efficiency based on fuel data of the vehicle. For example, as shown in FIG. 2, the baseline cost of $20.15 may be increased by $3.30 for the DELUXE vehicle. The vehicle may communicate fuel data detected by a fuel sensor of the vehicle to a remote data server, and the remote data server may determine the increase amount based on the fuel data. In some embodiments, the increase is determined by determining a vehicle operation cost for the inefficient vehicle and comparing the vehicle operation cost for the inefficient vehicle with the vehicle operation cost of the baseline cost. In some embodiments, the increase is determined by calculating an increase based on the fuel efficiency of the inefficient vehicle. For example, the fuel efficiency of the vehicle may be 18 miles per gallon. The fuel efficiency that is below a threshold value (e.g., 30 miles per gallon, 40 miles per gallon, 50 miles per gallon) may be multiplied by an increase factor (e.g., $0.15, $0.20, $0.30) to determine the increase. Thus, a vehicle with a fuel efficiency of 18 MPG which is below a threshold of 40 MPG by 22 MPG is multiplied by an increase factor of $0.15 to achieve an increase of $3.30. As shown in FIG. 2, the increase, once determined, is shown on the user interface 204.

The fuel data upon which the discount or increase is determined may be constantly changing, as the fuel data may be transmitted from the vehicle to the remote data server in real-time. For example, if the ECO vehicle is being operated in a fuel-inefficient manner, the fuel data reflecting this operation is communicated to the remote data server and the discount may be reduced in real-time. In some embodiments, a rolling average of fuel data may be used, so that there may not be drastically abrupt changes in the discount or increase.

The fuel data being detected by the fuel sensor on the vehicles and communicated in real-time to the remote data server improves MaaS technology by improving pricing accuracy for transportation.

Once the user has selected a transportation option 214, the user confirms by engaging the confirm icon 224. The remote data server receives the request and communicates an indication to the driver of the selected vehicle. The indication to the driver of the selected vehicle provides a location of the user so the driver may meet the user at the user's location as well as the destination location.

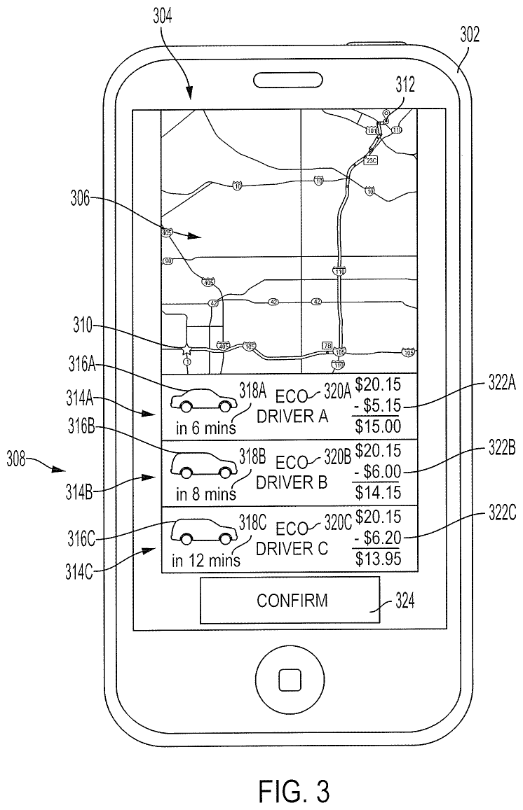

In some embodiments, further options may be presented to the user based on driver-specific data. FIG. 3 illustrates a mobile device 302 that is similar to mobile device 202. The mobile device 302 may be any device with a processor, a memory, an input device (e.g., touchscreen, mouse, keyboard, stylus, etc.), an output device (e.g., display screen, touchscreen, etc.), and a transceiver for communicating and receiving data. The mobile device 302 may be used by a user of the mobility as a service (MaaS) technology. As described herein, MaaS is a technology that allows users to access transportation without having to be in possession of a vehicle and uses multiple network-connected (e.g., Internet-connected) devices, such as network-connected mobile devices (e.g., mobile device 302) and network-connected vehicles (e.g., vehicle 102). These network-connected devices communicate in real-time to provide users with transportation.

The mobile device 302 is configured to render and display a user interface 304. The processor may render the user interface 304 and the output device may display the user interface 304. The user interface 304 includes a map 306 and a list 308. The map 306 shows the current location 310 of the user as well as the destination location 312 of the user. The current location 310 may be automatically detected using a location sensor of the mobile device 302 and the destination location 312 may be received from the user via an input device of the mobile device 302.

The list 308 includes one or more transportation options 314 (e.g., first option 314A, second option 314B, and third option 314C). Each transportation option 314 may include an image of the vehicle, an estimated time of arrival, a class of vehicle, a driver of the vehicle, and a cost of the vehicle. When the driver of the vehicle is taken into consideration, further granularity and accuracy of the pricing may be achieved, compared to taking into consideration only the vehicle capabilities and vehicle fuel efficiency.

The first option 314A includes an image of the vehicle 316A, a time estimate 318A, a class of vehicle 320A, and a cost 322A associated with the vehicle and the driver. Similarly, the second option 314B includes an image of the vehicle 316B, a time estimate 318B, a class of vehicle 320B, and a cost 322B associated with the vehicle and the driver. Similarly, the third option 314C includes an image of the vehicle 316C, a time estimate 318C, a class of vehicle 320C, and a cost 322C associated with the vehicle and the driver.

For each vehicle, the image of the vehicle 316 may be used to show the user a type of vehicle and/or a make and a model of the vehicle. The time estimate 318 may be determined based on real-time location data of the vehicle (detected by a location sensor of the vehicle) and real-time location data of the mobile device 302 (detected by a location sensor of the mobile device).

The cost associated with the vehicle may be determined based on a fuel efficiency of the vehicle and a fuel efficiency of the driver. A baseline cost may be determined and a discount or an additional cost may be applied to the baseline cost. For example, the baseline cost may be $20.15 for the transportation request. This baseline cost may be determined using any number of factors, including a time of day or a day of the week or a demand for transportation services relative to a supply of vehicles.

At least one of the components of the baseline cost may be a cost of operating the vehicle along the requested route. This vehicle operation cost component for the baseline cost may be determined based on fuel costs and fuel efficiency of an average vehicle. The vehicle operation cost may be combined with other costs, such as insurance costs or driver compensation costs, to form the baseline cost.

The baseline cost may be reduced for rides with drivers who operate their vehicles in fuel efficient manners. For example, as shown in FIG. 3, the baseline cost of $20.15 may be reduced by $5.15 for the ECO vehicle with Driver A.

The vehicle may communicate vehicle data detected by respective vehicle sensors of the vehicle to a remote data server, and the remote data server may determine the discount amount based on the vehicle data. The vehicle data may include fuel data and vehicle operational data (e.g., braking data, acceleration data, and engine data). The fuel data may include past and current real-time fuel data and the vehicle operational data may include past and current real-time vehicle operational data.

The fuel data may accurately represent the fuel efficiency of the driver over certain paths previously traveled. However, the fuel data may not accurately predict the fuel efficiency of the driver over paths that were not previously traveled by the driver. A driver's vehicle operational data (e.g., braking data, acceleration data, and engine data) may be used in addition to or in lieu of the fuel data when predicting or estimating a fuel efficiency of the driver over paths that were not previously traveled by the driver.

A driver's braking data may indicate fuel-efficient braking trends, such as coasting to a stop or fuel-inefficient trends, such as abrupt braking, and the driver's braking data may be used to project a vehicle operation cost during the route. A driver's acceleration data may indicate fuel-efficient acceleration trends, such as a steady increase in vehicle speeds and maintaining of fuel-efficient speeds or the acceleration data may indicate fuel-inefficient trends, such as sudden, aggressive acceleration. A driver's engine data may indicate fuel-efficient engine usage, such as use of engine braking or fuel-inefficient engine usage, such as use of aggressive driving modes (e.g., sport driving mode).

In some embodiments, the discount associated with the driver's fuel efficiency is calculated by determining a projected vehicle operation cost for the driver of the vehicle driving on the route and comparing the projected vehicle operation cost with the vehicle operation cost of the baseline cost. The baseline cost may be an average or median cost of all drivers to traverse a particular route or a similar route. For example, a vehicle operation cost of the baseline cost may be $18.89 and the projected vehicle operation cost for Driver A driving the route from the current location of the user to the destination location may be $13.74. Thus, the difference of $5.15 may be applied as the discount.

The projected vehicle operation cost for a driver may be determined based on previous vehicle data, and in many situations, the projected vehicle operation cost is based on a projected fuel efficiency and a projected fuel cost. In some embodiments, if the driver had previously driven the route or a similar route, the fuel data from the previous driving of the route may be used to determine the projected vehicle operation cost. In some embodiments, if the driver had not previously driven the route or a similar route, an estimate may be made based on the vehicle data (e.g., fuel data, braking data, acceleration data, and engine data) of the driver. For example, if the route includes 15 intersections, 12 miles of freeway, and moderate traffic, the driver's fuel efficiency when traversing intersections, the driver's fuel efficiency over freeways, and the driver's fuel efficiency in moderate traffic may all be included in the projected fuel cost.

In some embodiments, a fuel efficiency when traversing intersections may be based on driver fuel efficiency when traversing intersections with green lights, driver fuel efficiency when traversing intersections with yellow lights, and driver fuel efficiency when traversing intersections with red lights. A probability of encountering a green light, a yellow light, or a red light may be determined from historical traffic light data, and an expected value of fuel efficiency for an intersection for the driver may be determined.

A driver's fuel efficiency over various types of roads (e.g., paved roads, unpaved roads, freeways, surface streets) and a driver's fuel efficiency in various traffic conditions (e.g., no traffic, light traffic, moderate traffic, heavy traffic, etc.) may be determined based on historical driver fuel efficiency over the respective types of roads and traffic conditions. The historical driver fuel efficiency may be detected by the fuel sensor and stored in memory on the vehicle or on a remote data server. Traffic conditions and thresholds of each type of traffic condition may be determined based on the speeds of vehicles.

In some embodiments, the discount associated with the driver's fuel efficiency is determined by calculating a discount based on the fuel efficiency of the driver. For example, the fuel efficiency of the vehicle driven by the driver may be 120 miles per gallon gasoline equivalent (MPGe). The fuel efficiency exceeding a threshold value (e.g., 30 miles per gallon, 40 miles per gallon, 50 miles per gallon) may be multiplied by a discount factor (e.g., $0.06, $0.08, $0.10) to determine the discount. Thus, a vehicle with a fuel efficiency of 120 MPGe which exceeds a threshold of 40 MPG by 80 MPG is multiplied by a discount factor of $0.06 to achieve a discount of $4.80. As shown in FIG. 3, the discount, once determined, is shown on the user interface 304.

Also as shown in FIG. 3, more fuel-efficient vehicles are associated with a higher discount, and these discounts are shown on the user interface 304.

The vehicle data (e.g., fuel data, braking data, acceleration data, and engine data) upon which the discount or increase is determined may be constantly changing, as the vehicle data may be transmitted from the vehicle to the remote data server in real-time. For example, if Driver B is being operated in a less fuel-inefficient manner than is normally the case, the vehicle data reflecting this current operation is communicated to the remote data server and the discount may be reduced in real-time. In some embodiments, a rolling average of fuel data may be used, so that there may not be drastically abrupt changes in the discount or increase.

The fuel data being detected by the fuel sensor on the vehicles and communicated in real-time to the remote data server improves MaaS technology by improving pricing accuracy for transportation.

Once the user has selected a transportation option 314, the user confirms by engaging the confirm icon 324. The remote data server receives the request and communicates an indication to the driver of the selected vehicle. The indication to the driver of the selected vehicle provides a location of the user so the driver may meet the user at the user's location as well as the destination location.

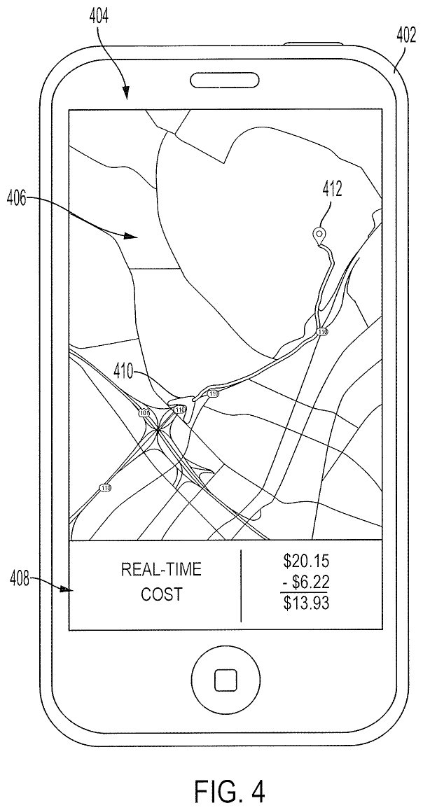

FIG. 4 illustrates adjustments to the transportation costs in real-time. As described herein, the costs associated with a transportation from a current location to a destination location may be adjusted in real-time. In some embodiments, if the driver is operating the vehicle in a more fuel-efficient manner than anticipated or if the vehicle is performing in a more fuel-efficient manner than anticipated, there may be a further discount of costs. In some embodiments, costs may only be lowered and not raised. In other embodiments, costs may be lowered or raised. Costs may be raised based on fuel efficiency if the driver is operating the vehicle in a less fuel-efficient manner than anticipated or if the vehicle is performing in a less fuel-efficient manner than anticipated.

FIG. 4 illustrates a mobile device 402 that is similar to mobile device 202 and mobile device 302. The mobile device 402 may be any device with a processor, a memory, an input device (e.g., touchscreen, mouse, keyboard, stylus, etc.), an output device (e.g., display screen, touchscreen, etc.), and a transceiver for communicating and receiving data. The mobile device 402 may be used by a user of the mobility as a service (MaaS) technology. As described herein, MaaS is a technology that allows users to access transportation without having to be in possession of a vehicle and uses multiple network-connected (e.g., Internet-connected) devices, such as network-connected mobile devices (e.g., mobile device 402) and network-connected vehicles (e.g., vehicle 102). These network-connected devices communicate in real-time to provide users with transportation.

The mobile device 402 is configured to render and display a user interface 404. The processor may render the user interface 404 and the output device may display the user interface 404. The user interface 404 includes a map 406 and a real-time cost portion 408. The map 406 shows the current location 410 of the user as well as the destination location 412 of the user. The current location 410 may be automatically detected using a location sensor of the mobile device 402 and the destination location 412 may be received from the user via an input device of the mobile device 402.

The real-time cost portion 408 may include the baseline cost (e.g., $20.15) as well as a discount (e.g., $6.22) and a total (e.g., $13.93). The discount portion may be updated in real-time as the trip progresses. For example, an original discount may have been $6.00 determined based on the vehicle fuel efficiency and/or the driver's fuel-efficient operation of the vehicle. However, as the user is transported to the destination location, the driver may operate the vehicle in more fuel-efficient ways, such as coasting to stops, driving at or near fuel-efficient vehicle speeds, or encountering more green lights at intersections than anticipated.

When the fuel efficiency of the vehicle improves compared to the projected or estimated fuel efficiency, the discount portion may be increased. The improvement in fuel efficiency may be detected by the fuel sensor of the vehicle. For example, if an estimated or projected fuel efficiency of a first portion of the trip results in an estimated fuel cost of $10.25, but the detected fuel efficiency after the first portion of the trip is traversed results in a fuel cost of $9.88, then the difference of $0.37 may be reduced from the total cost to the user. In some embodiments, the difference is divided between the driver and the user so that both parties benefit from the increased fuel efficiency of the driver. For example, the driver may have 70% of the savings in fuel cost added to the driver's earnings for the trip, and the remaining 30% may be used to reduce the user's transportation cost. Other ratios may be possible, including 50:50, 90:10; 10:90, 75:25, or 25:75, for example.

When the fuel sensor detects the actual fuel cost and when a computing device (e.g., an ECU) of the vehicle determines that the actual fuel cost is lower than the estimated or projected fuel cost, then the vehicle may communicate the fuel data to the remote data server, and the remote data server may communicate with the mobile device (e.g., mobile device 402) of the user. In turn, the mobile device of the user may render its user interface (e.g., user interface 404) to show the decrease in cost, in real-time.

In some embodiments, an alert or notification (e.g., an audible alert, a written alert, a vibration alert, etc.) may be generated by the mobile device when the real-time cost is changed, to draw the user's attention to the updated cost.

In many embodiments, a mobile device of the driver of the vehicle may show a similar real-time cost so that the driver is aware of the driver's operational impact on the cost. In some embodiments, although a driver's increase in fuel costs (by operating the vehicle inefficiently) may cause an increase in the transportation costs of the user, the driver's portion of the transportation costs may not be increased, in order to prevent or discourage the driver from intentionally operating the vehicle in an inefficient manner.

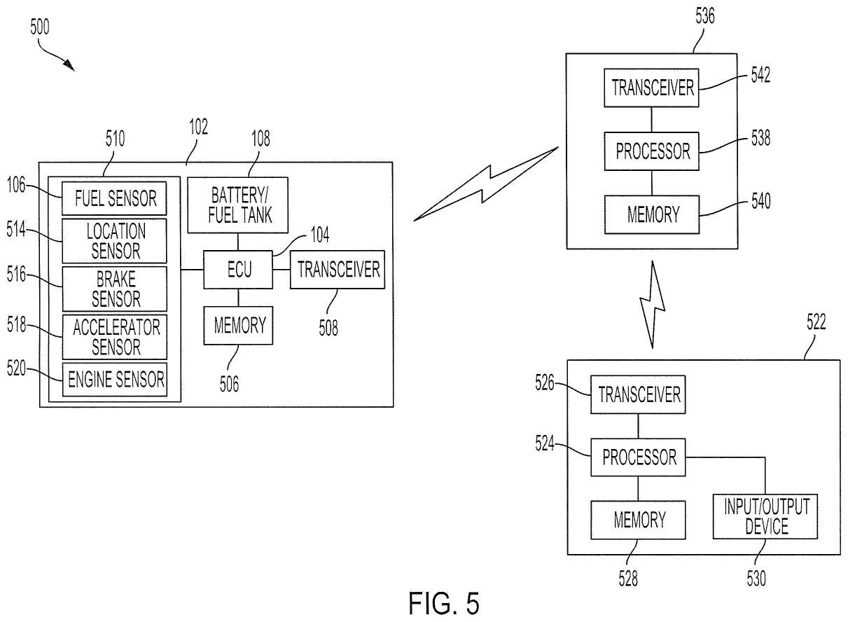

FIG. 5 illustrates an example system 500, according to various embodiments of the invention. The system may include a vehicle 102. The vehicle 102 may have an automatic or manual transmission. The vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor or battery driven vehicle. For example, the vehicle 102 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 102 may be a semi-autonomous vehicle or an autonomous vehicle. That is, the vehicle 102 may be self-maneuvering and navigate without human input. An autonomous vehicle may use one or more sensors and/or a navigation unit to drive autonomously.

The vehicle 102 also includes one or more computers, processors or electronic control units (ECUs) 104, appropriately programmed, to control one or more operations of the vehicle 102. The one or more ECUs 104 may include one or more processors and may be implemented as a single ECU or in multiple ECUs. The ECU 104 may be electrically coupled to some or all of the components of the vehicle 102. In some embodiments, the ECU 104 is a central ECU configured to control one or more operations of the entire vehicle. In some embodiments, the ECU 104 is multiple ECUs located within the vehicle and each configured to control one or more local operations of the vehicle. In some embodiments, the ECU 104 is one or more computer processors or controllers configured to execute instructions stored in a non-transitory memory 506.

Although FIG. 5 illustrates various elements connected to the ECU 104, the elements of the vehicle 102 may be connected to each other using a communications bus.

The vehicle 102 may be coupled to a network. The network, such as a local area network (LAN), a wide area network (WAN), a cellular network, a digital short-range communication (DSRC), the Internet, or a combination thereof, connects the vehicle 102 to a remote data server 536. The remote data server 536 may include a non-transitory memory 540, a processor 538 configured to execute instructions stored in the non-transitory memory 540, and a transceiver 542 configured to transmit and receive data to and from other devices, such as the vehicle 102. The remote data server 536 may be one or more servers from different service providers. Each of the one or more servers may be connected to one or more databases. A service provider may provide navigational map, weather and/or traffic data to the vehicle 102.

A database is any collection of pieces of information that is organized for search and retrieval, such as by a computer or a server, and the database may be organized in tables, schemas, queries, report, or any other data structures. A database may use any number of database management systems and may include a third-party server or website that stores or provides information. The information may include real-time information, continuously or periodically updated information, or user-inputted information. A server may be a computer in a network that is used to provide services, such as accessing files or sharing peripherals, to other computers in the network. A website may be a collection of one or more resources associated with a domain name.

The navigational map information includes political, roadway and construction information. The political information includes political features such as cities, states, zoning ordinances, laws and regulations, and traffic signs, such as a stop sign, traffic signals, or pedestrian crosswalks. For example, laws and regulations may include the regulated speed on different portions of a road or noise ordinances. The roadway information includes road features such the grade of an incline of a road, a terrain type of the road, or a curvature of the road. The construction information includes construction features such as construction zones and construction hazards.

The features, e.g., road features, political features, or traffic data, each have a location that may be identified by map coordinates. The map coordinates may be defined by latitude and longitude coordinates.

The transceiver 508 may include a communication port or channel, such as one or more of a Wi-Fi unit, a Bluetooth® unit, a Radio Frequency Identification (RFID) tag or a reader, a DSRC unit, or a cellular network unit for accessing a cellular network (such as 3G, 4G, or 5G). The transceiver 508 may transmit data to and receive data from devices and systems not directly connected to the vehicle. For example, the ECU 104 may communicate with the remote data server 536. Furthermore, the transceiver 508 may access the network, to which the remote data server 536 is also connected.

The vehicle 102 includes a sensor array 510 connected to the ECU 104. The sensor array includes a fuel sensor 106, a location sensor 514, a brake sensor 516, an accelerator sensor 518, an engine sensor 520, each as described herein.

The fuel sensor 106 may be coupled to the battery or fuel tank 108 to detect fuel data, such as a fuel level, a fuel consumption rate, or a fuel capacity, for example.

The location sensor 514 is configured to determine location data. The location sensor 514 may be a GPS unit or any other device for determining the location of the vehicle 102. The ECU 104 may use the location data along with the map data to determine a location of the vehicle 102. In other embodiments, the location sensor 514 has access to the map data and may determine the location of the vehicle 102 and provide the location of the vehicle 102 to the ECU 104.

The brake sensor 516 is configured to detect braking data. The braking data may indicate a timing and/or engagement level of the brake pedal by the driver. Similarly, the accelerator sensor 518 is configured to detect acceleration data. The acceleration data may indicate a timing and/or engagement level of the accelerator pedal by the driver. The brake sensor 516 may be configured to physically measure the degree of engagement of the brake pedal, or may be a sensor coupled to the output of the brake pedal which is used to instruct the brakes to be applied. Similarly, the accelerator sensor 518 may be configured to physically measure the degree of engagement of the accelerator pedal, or may be a sensor coupled to the output of the accelerator pedal which is used to instruct the engine or motor/generator to accelerate.

The engine sensor 520 is configured to detect engine data. The engine data may include any state or condition of the engine. The engine data may be used to detect engine braking or any other condition affecting fuel efficiency. While “engine” is used herein, the engine sensor 520 may be a motor sensor or a motor/generator sensor for electric vehicles.

The memory 506 is connected to the ECU 104 and may be connected to any other component of the vehicle 102. The memory 506 is configured to store any data described herein, such as the map data, the location data, the braking data, the acceleration data, the engine data, the fuel efficiency data, and any data received from the remote data server 536 via the transceiver 508.

Also included in the system is a mobile device 522 (e.g., mobile device 202, 302, 402), which includes a processor 524 configured to execute instructions stored in non-transitory memory 528. The mobile device 522 also includes a transceiver 526 similar to transceiver 508 and transceiver 542. The mobile device 522 also includes an input/output device 530 configured to receive inputs from the user and display outputs to the user, as described herein.

As used herein, a “unit” may refer to hardware components, such as one or more computer processors, controllers, or computing devices configured to execute instructions stored in a non-transitory memory.

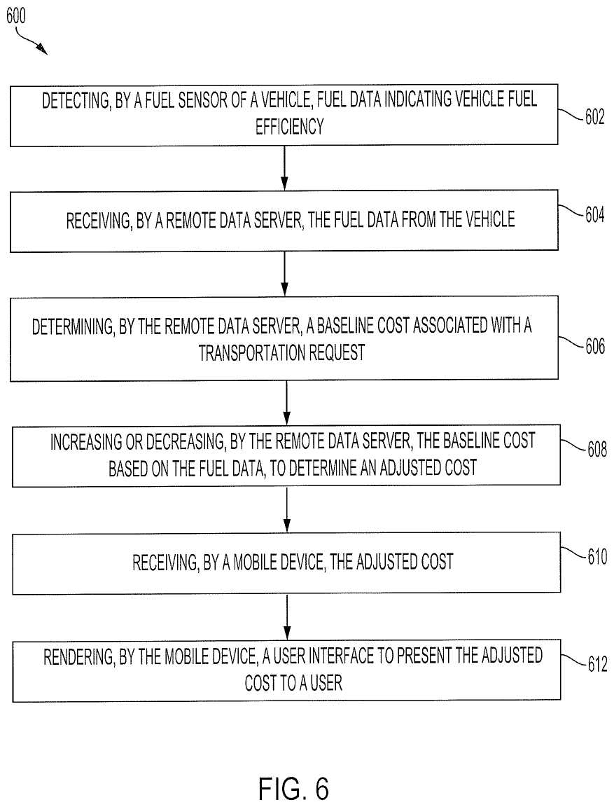

FIG. 6 illustrates a flowchart of a process 600 performed by the systems described herein.

A fuel sensor (e.g., fuel sensor 106) of a vehicle (e.g., vehicle 102) detects fuel data indicating vehicle fuel efficiency (step 602). The fuel data may include a current fuel consumption rate, historical fuel consumption rates, and a current fuel level, for example.

A remote data server (e.g., remote data server 536) receives the fuel data from the vehicle (step 604). The remote data server may also receive respective fuel data from a plurality of other vehicles.

The remote data server may also receive a transportation request from a mobile device (e.g., mobile device 522) of a user. The transportation request may include a current location of the mobile device or the user, as well as a destination location. The remote data server may determine a plurality of vehicles within a predetermined radius of the mobile device or the user that can fulfill the transportation request. The plurality of vehicles that can fulfill the transportation request may be determined using location sensors (e.g., location sensor 514) of the vehicles. The current location of the mobile device may be determined using a location sensor of the mobile device.

The remote data server determines a baseline cost associated with the transportation request, as described herein (step 606). The remote data server then determines an adjusted cost for each of the possible vehicles by increasing or decreasing the baseline cost based on the fuel data from the respective possible vehicles (step 608).

The remote data server communicates the adjusted cost of the possible vehicles to the mobile device. The mobile device receives the adjusted cost (step 610). The mobile device renders a user interface to present (e.g., via the output device) the adjusted cost to the user (step 612). The user interface may include a plurality of vehicles with respective adjusted costs, as described herein.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for improving accuracy of mobility technology, the system comprising:
a vehicle having a fuel sensor configured to detect fuel data indicating vehicle fuel efficiency, and an electronic control unit (ECU) configured to communicate the fuel data via a transceiver;
a remote data server configured to:
receive the fuel data from the vehicle,
determine a baseline cost associated with a transportation request, and
increase or decrease the baseline cost based on the fuel data to determine an adjusted cost; and
a mobile device configured to receive the adjusted cost and render a user interface to present the adjusted cost to a user.

2. The system of claim 1, wherein the mobile device is configured to receive the transportation request from the user and communicate the transportation request to the remote data server, and
wherein the remote data server is configured to identify, using respective location sensors of a plurality of vehicles, a plurality of eligible vehicles to fulfill the transportation request, and communicate an identification of at least one vehicle of the plurality of eligible vehicles to the mobile device.

3. The system of claim 1, wherein the remote data server increases or decreases the baseline cost by determining a fuel cost of fulfilling the transportation request by the vehicle and comparing a fuel component of the baseline cost with the fuel cost of fulfilling the transportation request by the vehicle.

4. The system of claim 3, wherein the fuel cost of fulfilling the transportation request by the vehicle is determined based on historical fuel data of the vehicle when the vehicle has previously travelled a route of the transportation request or a route similar to the route of the transportation request.

5. The system of claim 3, wherein the fuel cost of fulfilling the transportation request by the vehicle is determined based on a projected cost of the vehicle travelling a route of the transportation request.

6. The system of claim 5, wherein the projected cost is determined based on vehicle data of the vehicle, including at least one of brake data, accelerator data, or engine data to determine a projected fuel efficiency of the vehicle travelling the route of the transportation request.

7. The system of claim 1, wherein the remote data server increases or decreases the baseline cost by applying a discount factor or an increase factor to the fuel efficiency of the vehicle.

8. The system of claim 1, wherein the remote data server continuously receives updated real-time fuel data from the vehicle in real-time and increases or decreases the adjusted cost based on the updated real-time fuel data while the transportation request is being fulfilled, and
wherein the mobile device is further configured to receive the increased or decreased adjusted cost and render an updated user interface to present the increased or decreased adjusted cost to the user.

9. The system of claim 1, wherein the fuel sensor is configured to detect a distance travelled by the vehicle per unit of energy used by the vehicle.

10. The system of claim 1, wherein the fuel is at least one of electrical energy, gasoline, or hydrogen.

11. A method for improving accuracy of mobility technology, the method comprising:
detecting, by a fuel sensor of a vehicle, fuel data indicating vehicle fuel efficiency;
receiving, by a remote data server, the fuel data from the vehicle;
determining, by the remote data server, a baseline cost associated with a transportation request;
increasing or decreasing, by the remote data server, the baseline cost based on the fuel data, to determine an adjusted cost;
receiving, by a mobile device, the adjusted cost; and
rendering, by the mobile device, a user interface to present the adjusted cost to a user.

12. The method of claim 11, further comprising:
receiving, by the mobile device, the transportation request from the user;
receiving, by the remote data server, the transportation request from the mobile device;
identifying, by the remote data server, using respective location sensors of a plurality of vehicles, a plurality of eligible vehicles to fulfill the transportation request; and
communicating, by the remote data server, an identification of at least one vehicle of the plurality of eligible vehicles to the mobile device.

13. The method of claim 11, wherein the remote data server increases or decreases the baseline cost by determining a fuel cost of fulfilling the transportation request by the vehicle and comparing a fuel component of the baseline cost with the fuel cost of fulfilling the transportation request by the vehicle.

14. The method of claim 13, wherein the fuel cost of fulfilling the transportation request by the vehicle is determined based on historical fuel data of the vehicle when the vehicle has previously travelled a route of the transportation request or a route similar to the route of the transportation request.

15. The method of claim 13, wherein the fuel cost of fulfilling the transportation request by the vehicle is determined based on a projected cost of the vehicle travelling a route of the transportation request.

16. The method of claim 15, wherein the projected cost is determined based on vehicle data of the vehicle, including at least one of brake data, accelerator data, or engine data to determine a projected fuel efficiency of the vehicle travelling the route of the transportation request.

17. The method of claim 11, wherein the remote data server increases or decreases the baseline cost by applying a discount factor or an increase factor to the fuel efficiency of the vehicle.

18. The method of claim 11, further comprising:
continuously receiving, by the remote data server, updated real-time fuel data from the vehicle in real-time and increasing or decreasing the adjusted cost based on the updated real-time fuel data while the transportation request is being fulfilled;
receiving, by the mobile device, the increased or decreased adjusted cost; and
rendering, by the mobile device, an updated user interface to present the increased or decreased adjusted cost to the user.

19. A system for improving accuracy of mobility technology, the system comprising:
a plurality of vehicles each having a fuel sensor configured to detect fuel data indicating vehicle fuel efficiency;
a remote data server configured to:
receive respective fuel data from the plurality of vehicles,
determine a baseline cost associated with a transportation request, and
increase or decrease the baseline cost based on the respective fuel data to determine an adjusted cost for one or more vehicles of the plurality of vehicles; and
a mobile device configured to receive the adjusted cost for the one or more vehicles and render a user interface to present the adjusted costs to a user.

20. The system of claim 19, wherein the remote data server increases or decreases the baseline cost by determining a fuel cost of fulfilling the transportation request by the vehicle and comparing a fuel component of the baseline cost with the fuel cost of fulfilling the transportation request by the vehicle.
